(19) United States
(12) Patent Application Publication
(10) Pub. No.: US 2007/0076116 A1
(43) Pub. Date: Apr. 5, 2007

(54) Method and apparatus for dynamically adjusting the clock frequency of an imaging sensor in a digital imaging device

(76) Inventors: Amol S. Pandit, Singapore (SG); Douglas L. Franz, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/244,949

(22) Filed: Oct. 5, 2005

(51) Int. Cl. H04N 5/238

(52) U.S. Cl. 348/364

(57) ABSTRACT

A digital imaging device such as a digital camera has an imaging-sensor clock that may be adjusted dynamically in accordance with lighting conditions measured through feedback from the imaging sensor. Selecting a relatively higher clock frequency under bright conditions provides shorter shutter delay, and selecting a relatively lower clock frequency under dim conditions helps to reduce electrical noise. Dynamic adjustment of the clock frequency in this manner can also reduce power consumption, thereby extending battery life.

### FIELD OF THE INVENTION

The present invention relates generally to digital photography and more specifically to techniques for controlling an imaging sensor in a digital imaging device.

### BACKGROUND OF THE INVENTION

Digital imaging devices such as digital cameras and digital camcorders include some kind of imaging sensor to convert light energy to electrical energy. For example, a digital camera may have a charge-coupled-device (CCD) imaging sensor. Such an imaging sensor is controlled by a clock signal. A high-frequency clock signal facilitates capture of the specific instant in time that the photographer intended. However, a high clock frequency also increases electrical noise and power consumption. A lower-frequency clock signal, on the other hand, reduces electrical noise when images are captured under low light conditions.

Prior-art digital imaging devices operate at a fixed imaging-sensor clock frequency. Thus, it is apparent that there is a need in the art for a method and apparatus for dynamically adjusting the clock frequency of an imaging sensor in a digital imaging device.

### BRIEF DESCRIPTION OF THE DRAWINGS

FIG. 1A is a functional block diagram of a digital imaging device in accordance with an illustrative embodiment of the invention.

FIG. 1B is a block diagram of an imaging module of the digital imaging device shown in FIG. 1A in accordance with an illustrative embodiment of the invention.

FIG. 1C is a functional diagram of a memory of the digital imaging device shown in FIG. 1A in accordance with an illustrative embodiment of the invention.

FIG. 2 is a flowchart of the operation of the digital imaging device shown in FIGS. 1A-1C in accordance with an illustrative embodiment of the invention.

FIG. 3 is a flowchart of the operation of the digital imaging device shown in FIGS. 1A-1C in accordance with another illustrative embodiment of the invention.

### DETAILED DESCRIPTION OF THE INVENTION

The imaging sensor of a digital imaging device can be used to measure current lighting conditions. Such measurements may be made, for example, during a live preview mode of the digital imaging device. Steps such as repeating the measurement multiple times, separated by a brief delay, may be taken to verify the accuracy of the lighting measurements. If the measured lighting conditions are relatively bright, the clock signal that drives the imaging sensor may be switched to a higher frequency. If the measured lighting conditions are relatively dim, a correspondingly lower imaging-sensor clock frequency may be selected. Dynamically adjusting the frequency of the imaging-sensor clock in this fashion provides several advantages. First, shutter delay is shortened under bright conditions. Secondly, electrical noise is reduced under dim conditions. Thirdly, power consumption is reduced and, therefore, battery life is extended because a lower clock frequency is selected whenever lighting conditions allow.

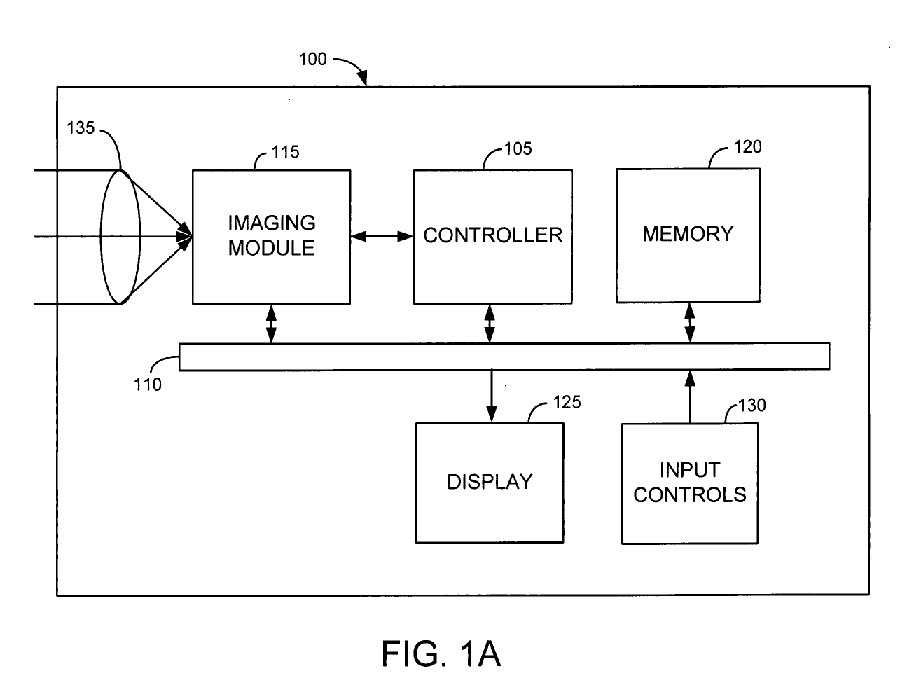

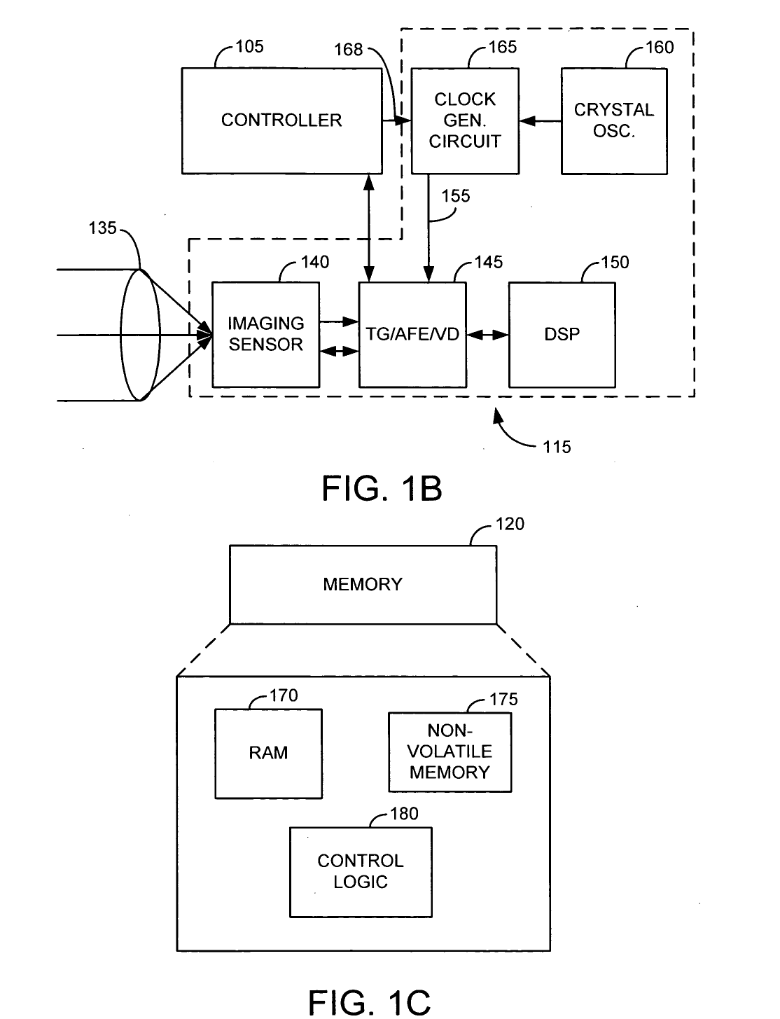

FIG. 1A is a functional block diagram of a digital imaging device 100 in accordance with an illustrative embodiment of the invention. Digital imaging device 100 may be any device capable of converting an optical image of a scene to a digital image. Examples include, without limitation, digital cameras, digital camcorders, personal digital assistants (PDAs) with digital camera functionality, and radiotelephones (e.g., cellular or PCS phones) with digital camera functionality. In FIG. 1A, controller 105 (e.g., a microprocessor or microcontroller) may communicate over data bus 110 with imaging module 115, memory 120, display 125, and input controls 130. Display 125 may be, for example, a liquid crystal display (LCD). Optical system 135 produces optical images that are converted to digital images by imaging module 115. Input controls 130 may include a shutter button, navigational buttons for browsing menus and captured digital images, and other input controls for controlling the operation of digital imaging device 100.

FIG. 1B is a block diagram of imaging module 115 in accordance with an illustrative embodiment of the invention. Imaging module 115 (enclosed by dotted lines in FIG. 1B) may comprise imaging sensor 140 (e.g., a charge-coupled device—CCD), a timing generator/analog front end/vertical driver (TG/AFE/VD) 145, and a digital signal processor (DSP) 150. As indicated in FIG. 1B, both data and control signals may connect imaging sensor 140 and TG/AFEND 145. TG/AFE/VD 145 controls the timing of imaging sensor 140 based on a clock signal 155 generated by crystal oscillator 160 and clock generation circuit 165 (e.g., a phase-locked loop—PLL—or a clock divider). Controller 105 may control clock generation circuit 165 (e.g., to set the frequency of clock signal 155) via clock control signal 168. Ultimately, clock signal 155 determines the rate at which imaging sensor 140 operates.

FIG. 1C is a functional diagram of memory 120 in accordance with an illustrative embodiment of the invention. Memory 120 may comprise random access memory (RAM) 170, non-volatile memory 175, and control logic 180. In some applications, non-volatile memory 175 may be of the removable variety (e.g., a secure digital or multi-media memory card). The functionality of control logic 180 will be described in greater detail in later portions of this detailed description. In general, control logic 180, which sets the frequency of clock signal 155 based on measured lighting conditions, may be implemented in software, firmware, hardware, or any combination thereof. In one illustrative embodiment, control logic 180 may comprise firmware that is executed by controller 105. In such an embodiment, controller 105 may set the frequency of clock signal 155 via clock control signal 168 in accordance with the firmware program instructions contained in control logic 180.

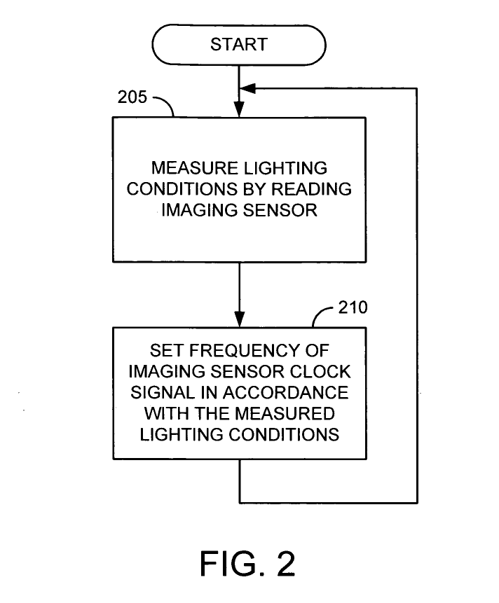

FIG. 2 is a flowchart of the operation of digital imaging device 100 in accordance with an illustrative embodiment of the invention. In FIG. 2, control logic 180 may, at 205, measure lighting conditions by examining feedback received from imaging sensor 140. At 210, control logic 180 may, via controller 105 and clock control signal 168, set the frequency of clock signal 155 in accordance with the measured lighting conditions. For example, control logic 180 may consult a lookup table to choose the appropriate clock frequency for particular measured lighting conditions. Setting the frequency of clock signal 155 may be accomplished by, for example, adjusting a PLL or clock divider (clock generation circuit 165), as explained above. As indicated in FIG. 2, this process may be repeated continually throughout the operation of digital imaging device 100, particularly during a live preview mode of digital imaging device 100. In live preview mode, display 125 may be updated at a video rate to show a user the scene currently being received from optical system 135. Such a live preview mode aids the user in composing a digital image to be captured by imaging module 115.

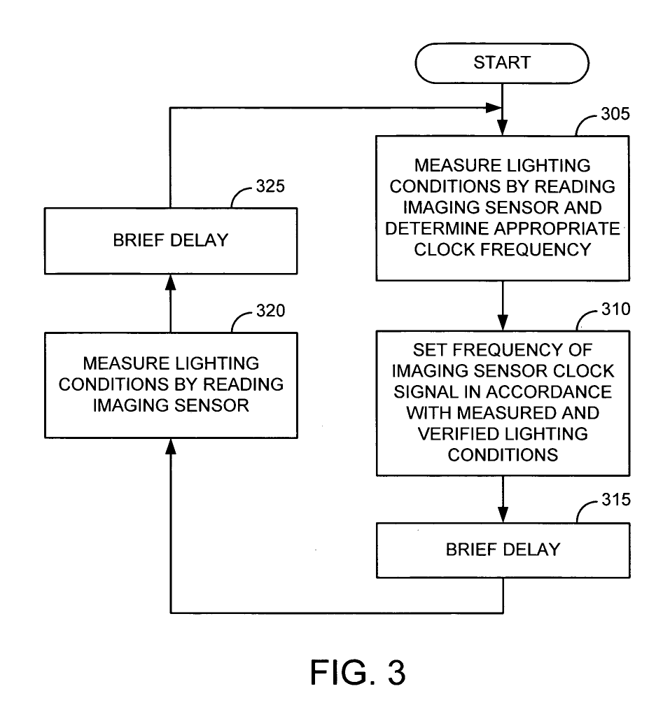

There is a possibility of adjusting the frequency of clock signal 155 too frequently, however. This can lead to undesirable effects such as variability in the appearance of live previews in live preview mode. Therefore, it can be advantageous to take steps to avoid unnecessary adjustment of clock signal 155. One approach to avoiding unnecessary adjustments is shown in the flowchart of FIG. 3, which describes the operation of digital imaging device 100 in accordance with another illustrative embodiment of the invention. In FIG. 3, lighting conditions are measured by reading imaging sensor 140 multiple times—i.e., two or more times (see steps 305 and 320). The multiple measurements of lighting conditions are separated by a brief, predetermined delay (e.g., several milliseconds), as shown at steps 315 and 325. This allows the lighting conditions to be verified before clock signal 155 is adjusted at step 310 in the manner explained above. A brief delay such as that performed at steps 315 and 325 is sometimes called a “firmware debounce” by those skilled in the art.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for controlling the operation of an imaging sensor in a digital imaging device, comprising:
measuring lighting conditions by reading the imaging sensor; and
setting the frequency of a clock signal that controls the imaging sensor in accordance with the measured lighting conditions.

2. The method of claim 1, wherein measuring lighting conditions by reading the imaging sensor is performed during a live preview mode of the digital imaging device.

3. The method of claim 1, wherein the frequency of the clock signal is set to a relatively higher value, when relatively brighter lighting conditions are measured, and the frequency of the clock signal is set to a relatively lower value, when relatively dimmer lighting conditions are measured.

4. The method of claim 1, wherein setting the frequency of the clock signal comprises adjusting a phase-locked loop that controls the clock signal.

5. The method of claim 1, wherein setting the frequency of the clock signal comprises adjusting a clock divider circuit that controls the clock signal.

6. The method of claim 1, further comprising:
avoiding unnecessary adjustment of the frequency of the clock signal.

7. The method of claim 6, wherein avoiding unnecessary adjustment of the frequency of the clock signal comprises reading the imaging sensor multiple times to verify the measured lighting conditions before setting the frequency of the clock signal in accordance with the measured lighting conditions, the multiple readings of the imaging sensor being separated by a brief predetermined delay.

8. The method of claim 1, wherein the imaging sensor comprises a charge-coupled-device.

9. The method of claim 1, wherein the digital imaging device comprises one of a digital camera, a digital camcorder, a personal digital assistant, and a radiotelephone.

10. A method for controlling the frequency of a clock signal that controls an imaging sensor in a digital imaging device, comprising:
reading the imaging sensor multiple times during a live preview mode of the digital imaging device to measure and verify lighting conditions;
waiting a brief predetermined period between readings of the imaging sensor; and
setting the frequency of the clock signal in accordance with the measured and verified lighting conditions.

11. The method of claim 10, wherein the imaging sensor comprises a charge-coupled-device.

12. The method of claim 10, wherein the digital imaging device comprises one of a digital camera, a digital camcorder, a personal digital assistant, and a radiotelephone.

13. A digital imaging device, comprising:
an optical system to produce optical images;
an imaging sensor to convert the optical images to digital images;
a circuit to generate a clock signal that controls the imaging sensor; and
control logic configured to adjust the frequency of the clock signal based on lighting conditions measured via feedback from the imaging sensor.

14. The digital imaging device of claim 13, wherein the circuit comprises one of a phase-locked loop and a clock divider.

15. The digital imaging device of claim 13, wherein the imaging sensor comprises a charge-coupled device.

16. The digital imaging device of claim 13, wherein the control logic is configured to adjust the frequency of the clock signal to a relatively higher value, when relatively brighter lighting conditions are measured, and to adjust the frequency of the clock signal to a relatively lower value, when relatively dimmer lighting conditions are measured.

17. The digital imaging device of claim 13, wherein the control logic is further configured to base its adjustment of the frequency of the clock signal on multiple readings of lighting conditions from the imaging sensor, the multiple readings being separated by a brief predetermined delay.

18. The digital imaging device of claim 13, wherein the digital imaging device comprises one of a digital camera, a digital camcorder, a personal digital assistant, and a radiotelephone.

19. A digital imaging device, comprising:
means for producing optical images;
means for converting the optical images to digital images;
means for generating a clock signal to control the imaging sensor; and
means for automatically adjusting the frequency of the clock signal based on lighting conditions measured via feedback from the imaging sensor.

20. The digital imaging device of claim 19, wherein the means for automatically adjusting the frequency of the clock signal is configured to adjust the frequency of the clock signal to a relatively higher value, when relatively brighter lighting conditions are measured, and to adjust the frequency of the clock signal to a relatively lower value, when relatively dimmer lighting conditions are measured.
